(19) United States
(12) Patent Application Publication
(10) Pub. No.: US 2012/0039180 A1
(43) Pub. Date: Feb. 16, 2012

(54) APPARATUS AND METHOD FOR MONITORING CONTROL CHANNEL IN MULTI-CARRIER SYSTEM

(75) Inventors: So Yeon Kim, Anyang-si (KR); Jae Hoon Chung, Anyang-si (KR); Yeong Hyeon Kwon, Anyang-si (KR); Sung Ho Moon, Anyang-si (KR)

(73) Assignee: LG Electronics Inc., Seoul (KR)

(21) Appl. No.: 13/264,607

(22) PCT Filed: Apr. 16, 2010
(86) PCT No.: PCT/KR10/02369

§ 371 Date: Oct. 14, 2011

Related U.S. Application Data
(60) Provisional application No. 61/170,092, filed on Apr. 16, 2009.
(60) Provisional application No. 61/291,353, filed on Dec. 30, 2009.
(60) Provisional application No. 61/292,172, filed on Jan. 5, 2010.

(30) Foreign Application Priority Data
Apr. 16, 2010 (JP) 10-2010-0035062

(51) Int. Cl. H04W 24/00

(52) U.S. Cl. 370/241

(57) ABSTRACT

A method and an apparatus for monitoring a control channel in a multi-carrier system are provided. A terminal sets a common downlink carrier for monitoring a plurality of candidate control channels for receiving common control information among multiples carriers, and monitors the candidate control channels within a common search space of the common downlink carrier. The terminal receives common control information on a control channel which has been successfully decoded from among a plurality of candidate control channels. The invention can reduce a load due to blind decoding of the control channels and decrease battery consumption of the terminal.

### TECHNICAL FIELD

The present invention relates to radio communication, and more particularly, to an apparatus and a method for monitoring a control channel in a wireless communication system.

### BACKGROUND ART

A wireless communication system has been widely distributed so as to provide various types of communication services, such as audio, data, or the like. Generally, the radio communication system is a multiple access system that shares available system resources (bandwidth, transmit power, or the like) to support communication with multiple users. An example of a multiple access system may include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, or the like.

In a general wireless communication system, even though a bandwidth between an uplink and a downlink is differently set, only a single carrier is mainly considered. A carrier is defined as a central frequency and a bandwidth. A multi-carrier system uses a plurality of carriers having a bandwidth smaller than an overall bandwidth.

3rd generation partnership project (3GPP) technical specification (TS) release 8 based long term evolution (LTE) is a prominent next-generation mobile communication standard.

As described in 3GPP TS 36. 211 V8.5.0 (2008-12) “Evolved Universal Terrestrial Radio Access (E-UTRA); Physical Channels and Modulation (Release 8)”, a physical channel in the LTE may be divided into a physical downlink shared channel (PDSCH) and a physical uplink shared channel (PUSCH) that are a data channel and a physical downlink control channel (PDCCH), a physical control format indicator channel (PCFICH), a physical hybrid-ARQ indicator channel (PHICH), and a physical uplink control channel (PUCCH) that are a control channel.

The 3GPP LTE system supports only a single bandwidth (that is, a single carrier) among {1, 4, 3, 5, 10, 15, 20} MHz. The multi-carrier system uses two carriers having 20 MHz bandwidth or three carriers having 20 MHz bandwidth, 15 MHz bandwidth, and 5 MHz bandwidth, respectively, so as to support the overall bandwidth of 40 MHz.

The multi-carrier system may support backward compatibility with the existing system and may greatly increase a data rate through multi carriers.

In the single carrier system, the control channel and the data channel have been designed based on the single carrier. However, using a channel structure of the single carrier system as it is in the multi-carrier system may be inefficient.

### DISCLOSURE

### Technical Problem

The present invention has been made in an effort to provide a method and an apparatus for monitoring a control channel in a multi-carrier system. Further, the present invention has been made in an effort to provide a method and an apparatus for transmitting a control channel in a multi-carrier system.

### Technical Solution

In an aspect, a method for monitoring a control channel in a multi-carrier system is provided. The method includes configuring a common downlink carrier for monitoring a plurality of candidate control channels used to receive common control information among a plurality of carriers, monitoring the plurality of candidate control channels in a common search space of the common downlink carrier, and receiving the common control information on the control channel that is successfully decoded among the plurality of candidate control channels.

A downlink grant can be received on the control channel and the common control information can be received on a data channel indicated by the downlink grant.

The data channel can be received through a downlink carrier different from the common downlink carrier.

The downlink grant can include a carrier indicator field (CIF) indicating the downlink carrier used to receive the data channel.

The common control information can include at least one of system information, a paging message, a random access response, and a transmit power control (TPC) command.

In another aspect, a user equipment for monitoring a control channel in a multi-carrier system includes an RF unit for transmitting and receiving radio signals, and a processor operatively connected to the RF unit and configured to configure a common downlink carrier for monitoring a plurality of candidate control channels used to receive common control information among a plurality of carriers, monitor the plurality of candidate control channels in a common search space of the common downlink carrier, and receive the common control information on the control channel that is successfully decoded among the plurality of candidate control channels.

### Advantageous Effects

The mechanism of transmitting and receiving the common control information in the multi-carrier system has been proposed. The exemplary embodiments of the present invention can reduce the load caused by the blind decoding of the control channel and the battery consumption of the user equipment by limiting the carriers used to receive or transmit common control information.

### DESCRIPTION OF DRAWINGS

FIG. 1 is a diagram showing a radio communication system.

FIG. 2 is a diagram showing a structure of a radio frame in 3GPP LTE.

FIG. 3 is a diagram showing a structure of a downlink subframe in the 3GPP LTE.

FIG. 4 is an exemplified diagram showing a transmission of an uplink data.

FIG. 5 is an exemplified diagram showing a reception of a downlink data.

FIG. 6 is a block diagram showing a configuration of PDCCH.

FIG. 7 is a diagram showing an example of resource mapping of the PDCCH.

FIG. 8 is an exemplified diagram showing a monitoring of the PDCCH.

FIG. 9 is a diagram showing an example of a transmitter and a receiver in which a single MAC operates multi carriers.

FIG. 10 is a diagram showing an example of the transmitter and the receiver in which multiple MACs operate the multi carriers.

FIG. 11 is a diagram showing another example of the transmitter and the receiver in which the multiple MACs operate the multi carriers.

FIG. 12 is a diagram showing an example of separate coding.

FIG. 13 is a diagram showing an example of joint coding.

FIG. 14 is a diagram showing an example of a linkage between DL CC and UL CC.

FIG. 15 is a diagram showing another example of the linkage between the DL CC and the UL CC.

FIG. 16 is a diagram showing an example of the common control information transmission.

FIG. 17 is a diagram showing another example of the common control information transmission.

FIG. 18 is a diagram showing a monitoring of a paging message.

FIG. 19 is a diagram showing a random access process limiting monitored CC.

FIG. 20 is a diagram showing an example of the common control information transmission for non-monitored carriers.

FIG. 21 is a block diagram showing a radio communication system according to an exemplary embodiment of the present invention.

### MODE FOR INVENTION

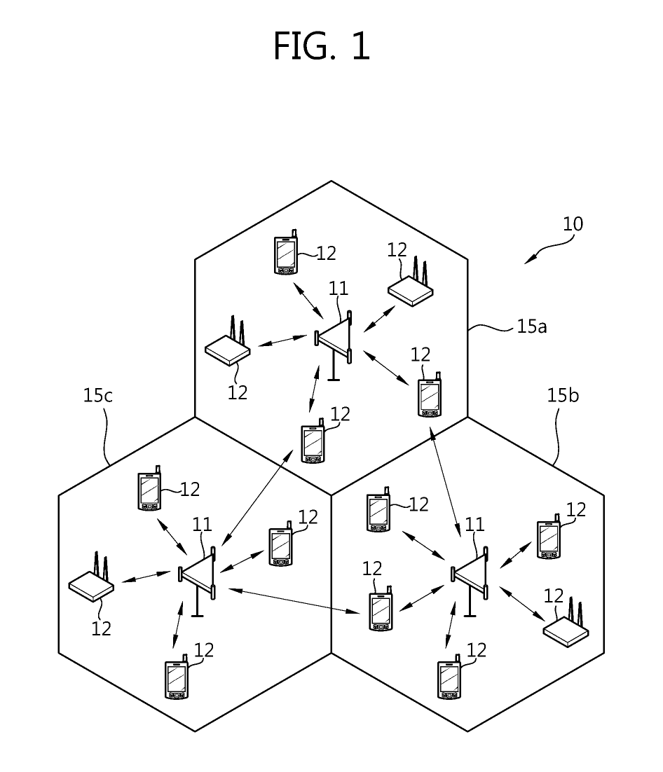

FIG. 1 is a diagram showing a radio communication system. A radio communication system 10 includes at least one base station (BS) 11. Each base station 11 provides communication services in specific geographical areas (generally referred to as a cell) 15a, 15b, and 15c. The cell may be divided into a plurality of areas (referred to as a sector).

A user equipment (UE) 12 may be fixed or moved and may be referred to as other terms, such as a mobile station (MS), a mobile terminal (MT), a user terminal (UT), a subscriber station (SS), a wireless device, a personal digital assistant (PDA), a wireless modem, a handheld device, or the like.

The base station 11 is generally referred to as a fixed station that communicates with the UE 12 and may be referred to as other terms, such as evolved-NodeB (eNB), a base transceiver system (BTS), an access point, or the like.

Hereinafter, downlink (DL) means communication from a base station to a user equipment and uplink (UL) means communication from a user equipment to a base station. The transmitter in the downlink may be a portion of the base station and the receiver may be a portion of the UE. The transmitter in the uplink may be a portion of the UE and the receiver may be a portion of the base station.

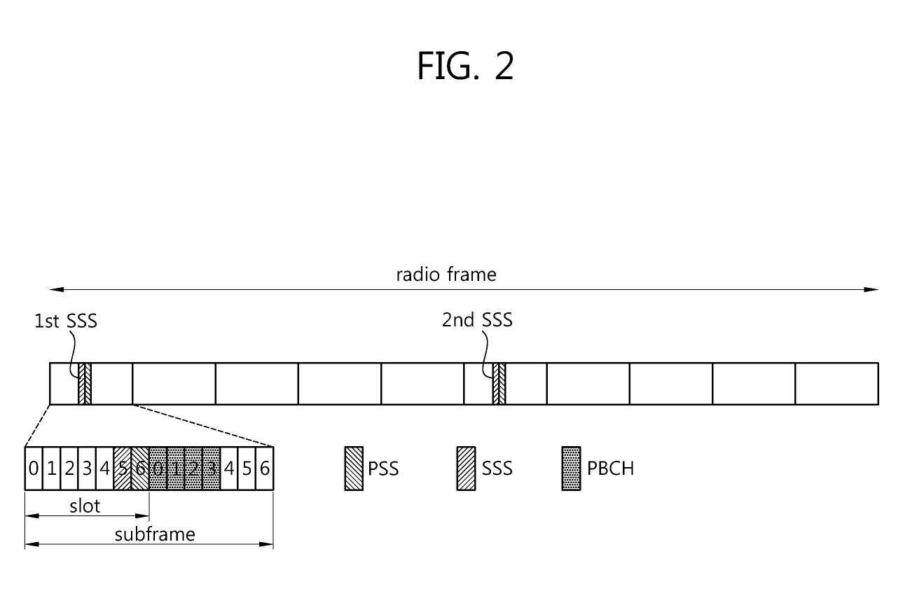

FIG. 2 is a diagram showing a structure of a radio frame in 3GPP LTE. This may refer to section 6 of 3GPP TS 36.211 V8.5.0 (2008-12) “Evolved Universal Terrestrial Radio Access (E-UTRA); Physical Channels and Modulation (Release 8)”. A radio frame is configured to have 10 subframes denoted by indexes of 0 to 9 and a single subframe is configured to have two slots. Time consumed to transmit the single subframe is referred to as a transmission time interval (TTI). For example, a length of the single subframe may be 1 ms and a length of the single slot may be 0.5 ms.

A single slot may include a plurality of orthogonal frequency division multiplexing (OFDM) symbols in a time domain. Since the 3GPP LTE uses the orthogonal frequency division multiple access (OFDM), the OFDM symbol is only to represent a single symbol period in the time domain. As a result, a multiple access method or a name is not limited. For example, the OFDM symbol may be referred to as other names, such as a single carrier frequency division multiple access (SC-FDMA) symbol, a symbol period, or the like.

A case in which the single slot includes 7 OFDM symbols is exemplarily described, but the number of OFDM symbols included in the single slot may be changed according to a length of a cyclic prefix (CC). According to the 3GPP TS 36.211 V8.5.0 (2008-12), in a normal CP, 1 subframe includes 7 OFDM symbols and in an extended CP, 1 subframe includes 6 OFDM symbols.

A primary synchronization signal (PSS) is transmitted to final OFMD symbols of a first slot (a first slot of a first subframe (a subframe of which the index is 0)) and an eleventh slot (a first slot of a sixth subframe (a subframe of which the index is 5)). The PSS is used to obtain OFDM symbol synchronization or slot synchronization and is associated with a physical cell identity (ID). A primary synchronization code (PSC) is a sequence used in the PSS and the 3GPP LTE has three PSCs. One of three PSCs is transmitted to the PSS according to the cell ID. The same PSC is used for the final OFDM symbols of the first slot and the eleventh slot, respectively.

A secondary synchronization signal (SSS) includes a first SSS and a second SSS. The first SSS and the second SSS are transmitted in an OFDM symbol adjacent to the OFDM symbol in which the PSS is transmitted. The SSS is used to obtain the frame synchronization. The SSS is used to obtain the cell ID together with the PSS. The first SSS and the second SSS use different secondary synchronization codes (SSC). When the first SSS and the second SSS each include 31 subcarriers, the two SSCs which have a length of 31 respectively are used for the first SSS and the second SSS.

A physical broadcast channel (PBCH) is transmitted in preceding four OFDM symbols of a second slot of the first subframe. The PBCH carries system information essential to allow the UE to communicate with the base station, wherein the system information transmitted through the PBCH is referred to as a master information block (MIB). By comparing therewith, the system information transmitted to a physical downlink shared channel (PDSCH) indicated by a physical downlink control channel (PDCCH) is referred to as a system information block (SIB).

As described in the 3GPP TS 36.211 V8.5.0 (2008-12), the LTE divides a physical channel into a physical downlink shared channel (PDSCH) and a physical uplink shared channel (PUSCH) that are a data channel and a physical downlink control channel (PDCCH) and a physical uplink control channel (PUCCH) that are a control channel.

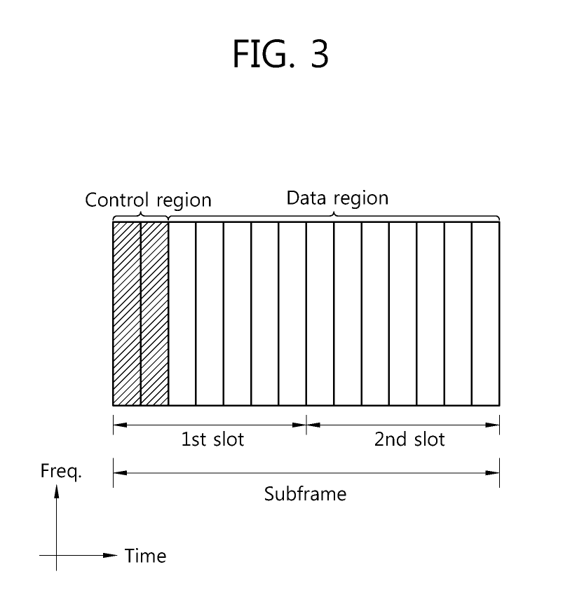

FIG. 3 is a diagram showing a structure of a downlink subframe in the 3GPP LTE. The subframe is divided into a control region and a data region in the time domain. The control region includes a maximum of preceding four OFDM symbols of the first slot within the subframe, but the number of OFDM symbols included in the control region may be changed. The PDCCH is allocated to the control region and the PDSCH is allocated to the data region.

A resource block (RB), which is a resource allocation unit, includes a plurality of subcarriers in the single slot. For example, when the single slot includes 7 OFDM symbols in the time domain and the resource block includes 12 subcarriers in a frequency domain, the single resource block may include 7×12 resource elements (RE).

The control information transmitted through the PDCCH is referred to as downlink control information (DCI). The DCI may include resource allocation of the PDSCH (referred to as a downlink grant), resource allocation of the PUSCH (referred to as an uplink grant), activation of a set of transmit power control commands and/or Voice over Internet Protocol (VoIP) for individual UEs within any UE group.

The PCFICH transmitted in the first OFDM symbol of the subframe carries a control format indicator (CFI) regarding the number of OFDM symbols (that is, a size of the control region) used to transmit the control channels within the subframe. The UE first transmits the CFI on the PCFICH and then, monitors the PDCCH.

The PHICH carries positive-acknowledgement (ACK)/negative acknowledgement (NAKC) signals for an uplink hybrid automatic repeat request (HARQ). The ACK/NACK signal for the uplink data transmitted by the UE is transmitted to the PHCIH.

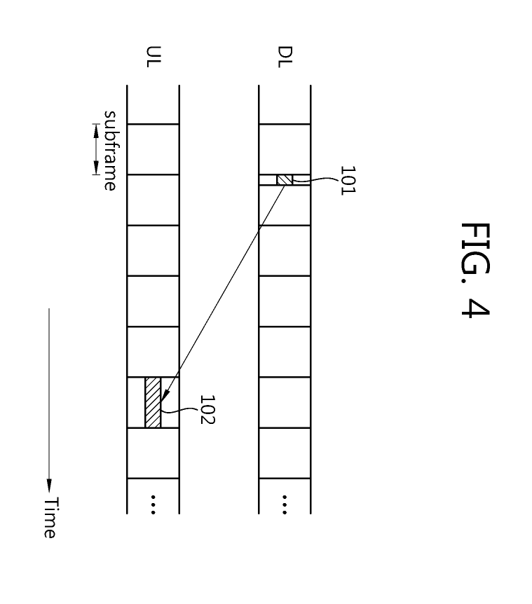

FIG. 4 is an exemplified diagram showing a transmission of an uplink data. The UE monitors the PDCCH in the downlink subframe and transmits uplink resource allocation on PDCCH 101. The UE transmits an uplink data packet to a PUSCH 102 configured based on the uplink resource allocation.

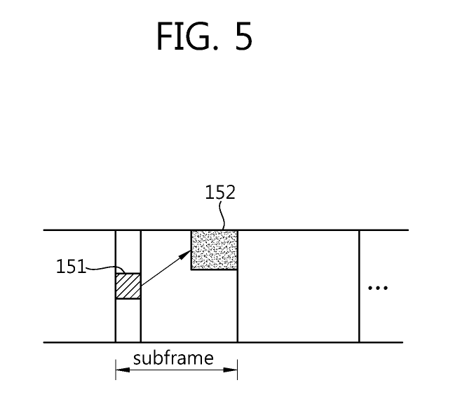

FIG. 5 is an exemplified diagram showing a reception of a downlink data. The UE receives a downlink data packet on a PDSCH 152 indicated by a PDCCH 151. The UE monitors the PDCCH in the downlink subframe and receives downlink resource allocation on PDCCH 151. The UE receives the downlink data packet to the PDSCH 152 that indicates the uplink resource allocation.

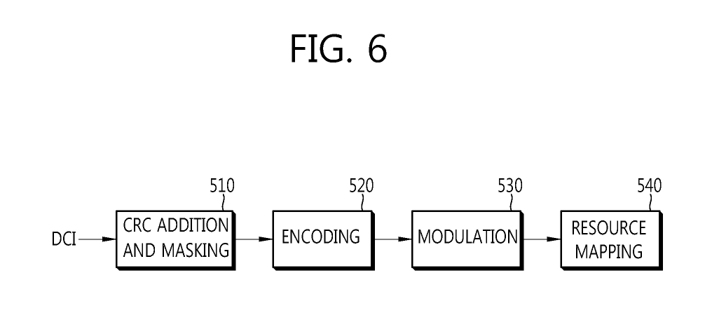

FIG. 6 is a block diagram showing a configuration of the PDCCH. The base station determines a PDCCH format according to the DCI to be transmitted to the UE and then, attaches a cyclic redundancy check (CRC) to the DCI and masks a unique identifier (referred to as a radio network temporary identifier (RNTI)) to the CRC according to an owner or a usage of the PDCCH (510).

In the case of the PDCCH for specific UE, the unique identifier of the UE, for example, a cell-RNTI (C-RNTI) may be masked to the CRC. Alternatively, in the case of the PDCCH for the paging message, a paging indication identifier, for example, a paging-RNTI (P-RNTI) may be masked to the CRC. In the case of the PDCCH for the system information, a system information identifier and a system information-RNTI (SI-RNTI) may be masked to the CRC. In order to indicate a random access response that is a response to a transmission of a random access preamble of the UE, a random access-RNTI (RA-RNTI) may be masked to the CRC. In order to indicate a transmit power control (TPC) command for the plurality of UEs, a TPC-RNTI may be masked to the CRC.

When the C-RNTI is used, the PDCCH carries control information on the specific UE (referred to as UE-specific control information) and when another RNTI is used, the PDCCH carries common control information received by all or the plurality of UEs within the cell.

Data coded by encoding the DCI to which the CRC is added is generated (520). The encoding includes channel encoding and rate matching.

The coded data are modulated to generate modulation symbols (530).

The modulation symbols are mapped to a physical resource element (RE) (540). Each of the modulation symbols are mapped to the RE.

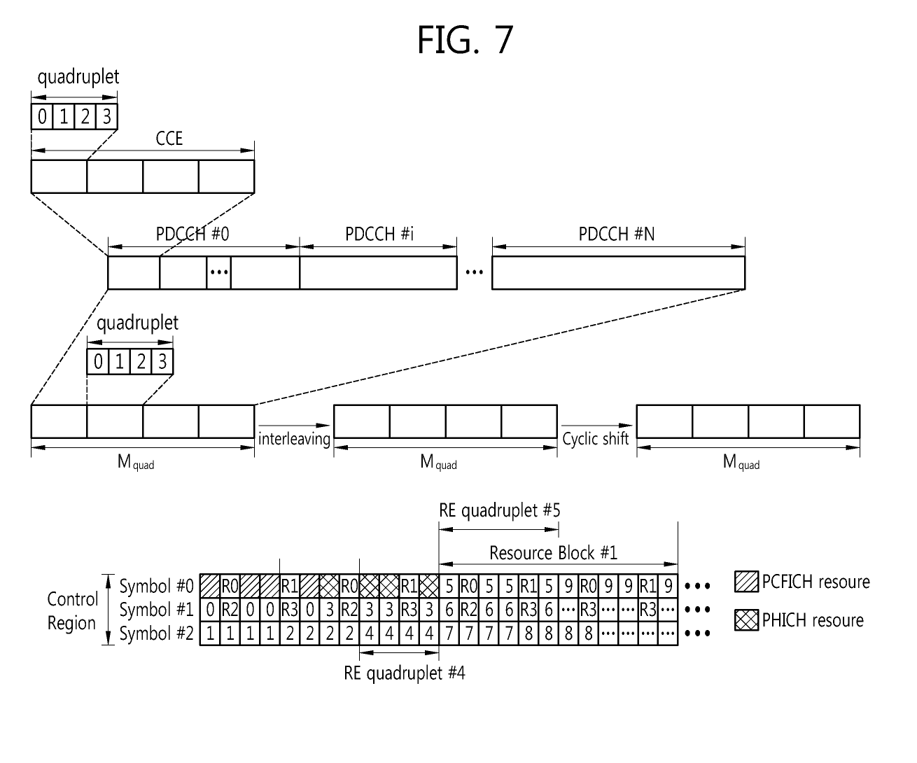

FIG. 7 is a diagram showing an example of resource mapping of the PDCCH. This may refer to section 6.8 of the 3GPP TS 36.211 V8.5.0 (2008-12). R0 represents a reference signal of a first antenna, R1 represents a reference signal of a second antenna, R2 represents a reference signal of a third antenna, and R3 represents a reference signal of a fourth antenna.

The control region within the subframe includes a plurality of control channel elements (CCE). The CCE, which is a logical allocation unit used to provide a coding rate depending on a status of a radio channel to the PDCCH, corresponds to a plurality of resource element groups (REG). A format of the PDCCH and a possible bit number of the PDCCH are determined according to the relationship between the number of CCEs and the coding rate provided by the CCEs.

The single REG (represented by a quadruplet in the drawings) includes four REs and the single CCE includes nine REGs. In order to configure the single PDCCH, {1, 2, 4, 8} CCEs may be used and each {1, 2, 4, 8} element may be referred to as a CCE aggregation level.

The control channel configured of at least one CCE performs interleaving in an REG unit and a cyclic shift based on the cell identifier (ID) is performed and then, is mapped to a physical resource.

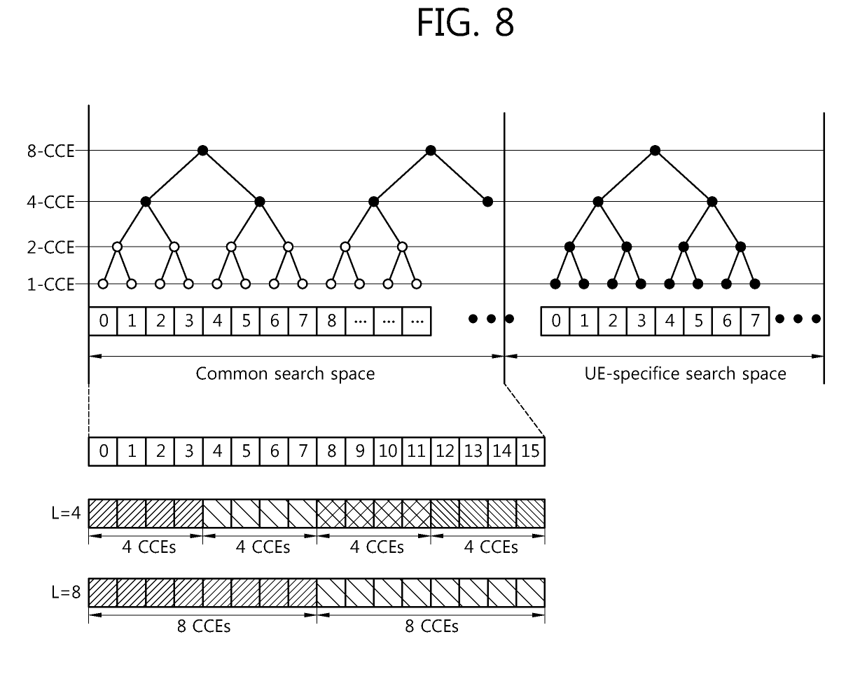

FIG. 8 is an exemplified diagram showing a monitoring of the PDCCH. This may refer to section 9 of the 3GPP TS 36.213 V8.5.0 (2008-12). The 3GPP LTE uses blind decoding for the PDCCH detection. The blind decoding is a scheme that checks CRC error by demasking a desired identifier to the CRC of the received PDCCH (referred to as a candidate PDCCH) so as to confirm whether the corresponding PDCCH is its own control channel. The UE does not know whether the PDCCH of the UE is transmitted using any CCE aggregation level or a DCI format at any position within the control region.

The plurality of PDCCH may be transmitted within the single subframe. The UE monitors the plurality of PDCCHs for each subframe. Herein, the monitoring means allowing the UE to attempt the decoding of the PDCCH according to the monitored PDCCH format.

In the 3GPP LTE, a search space is used to reduce a burden due to the blind decoding. The search space may be referred to as a monitoring set of the CCE for the PDCCH. The UE monitors the PDCCH within the corresponding search space.

The search space is divided into a common search space and a UE-specific search space. The common search space, which is a space searching the PDCCH having the common control information, is configured to have 16 CCEs up to CCE index of 0 to 15 and supports the PDCCH having the CCE aggregation level of {4, 8}. However, the PDCCH (DCI format 0, 1A) carrying the UE-specific information may also be transmitted to the common search space. The UE-specific search space supports the PDCCH having the CCE aggregation level of {1, 2, 4, 8}.

The following Table 1 represents the number of PDCCH candidates monitored by the UE.

TABLE 1

| Search | Aggregation | Size | Number of PDCCH | DCI |
|---|---|---|---|---|
| Space Type | level L | [In CCEs] | candidates | formats |
| UE-specific | 1 | 6 | 6 | 0, 1, |
| | 2 | 12 | 6 | 1A, 1B, |
| | 4 | 8 | 2 | 1D, 2, |
| | 8 | 16 | 2 | 2A |
| Common | 4 | 16 | 4 | 0, 1A, |
| | 8 | 16 | 2 | 1C, 3/3A |

The size of the search space is defined by the above Table 1 and a start point of the search space is differently defined in the common search space and the UE-specific search space. The start point of the common search space is fixed regardless of the subframe, but the start point of the UE-specific search space may be changed for each subframe according to a UE identifier (for example, C-RNTI), the CCE aggregation level, and/or a slot number within the radio frame. When the start point of the UE-specific search space is in the common search space, the UE-specific search space and the common search space may overlap each other.

A multiple carrier system will be described below.

The 3GPP LTE system supports a case in which a downlink bandwidth and an uplink bandwidth are differently set, which is made under a precondition of a single component carrier (CC). This means that the 3GPP LTE supports only the case in which the downlink bandwidth and the uplink bandwidth are the same or different under the situation in which a single component carrier for the downlink and the uplink, respectively, is defined. For example, the 3GPP LTE system supports a maximum of 20 MHz and may have different uplink bandwidth and downlink bandwidth, but supports only the single component carrier in the uplink and the downlink.

Spectrum aggregation (or, referred to as bandwidth aggregation and carrier aggregation) supports the plurality of component carriers. The spectrum aggregation is introduced to support increased throughput, prevent an increase in cost due to an introduction of a broadband radio frequency (RF) device, and secure compatibility with the existing system. For example, when five carriers are allocated as granularity in a carrier unit having a bandwidth of 20 MHz, the 3GPP LTE system may support a maximum bandwidth of 100 MHz.

The spectrum aggregation may be divided into contiguous spectrum aggregation formed between continuous carriers in the frequency domain and non-contiguous spectrum aggregation formed between carriers in which aggregation is discontinuous. The number of CCs aggregated between the uplink and the downlink may be differently set. The case in which the number of downlink CCs and the number of uplink CCs are the same is symmetric aggregation and the case in which the number of downlink CCs and the number of uplink CCs are different is referred to as asymmetric aggregation.

The size of the CCs (that is, bandwidth) may be different from each other. For example, when five CCs are used to configure a bandwidth of 70 MHz, the five CCs may be configured like 5 MHz carrier (CC #0)+20 MHz carrier (CC #1)+20 MHz carrier (CC #2)+20 MHz carrier (CC #3)+5 MHz carrier (CC #4).

Hereinafter, the multiple carrier system means a system supporting the multi carriers based on the spectrum aggregation. The contiguous spectrum aggregation and/or the non-contiguous spectrum aggregation may be used in the multiple carrier system. Further, both of the symmetric aggregation or the asymmetric aggregation may be used.

At least one medium access control (MAC) entity may manage/operate at least one CC so as to be transmitted and received. The MAC entity has an upper layer of the physical layer (PHY). For example, the MAC entity may be implemented by the MAC layer and/or the upper layer.

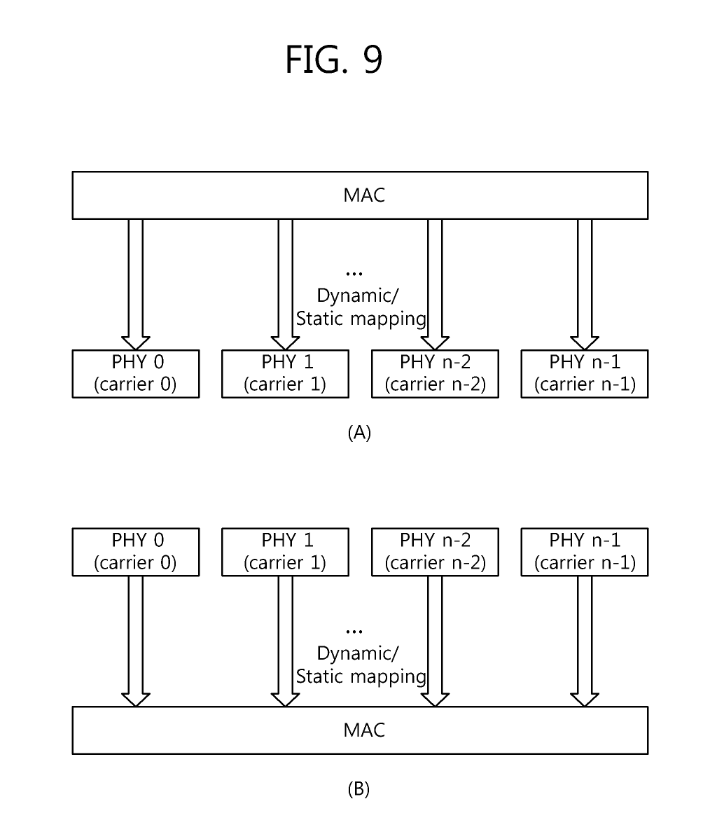

FIG. 9 is a diagram showing an example of a transmitter and a receiver in which a single MAC operates the multi carriers. FIG. 9A is a transmitter and FIG. 9B is a receiver. The single physical layer (PHY) corresponds to a single CC and a plurality of physical layers (PHY 0, . . . , PHY n−1) is operated by the single MAC. The mapping between the MAC and the plurality of physical layers (PHY 0, . . . , PHY n−1) may be dynamically or statically performed.

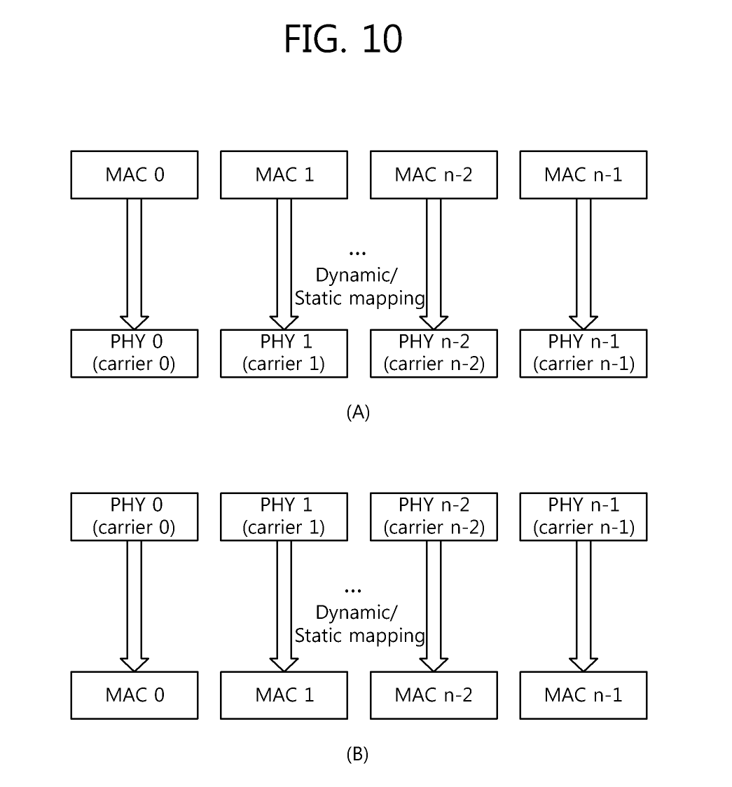

FIG. 10 is a diagram showing an example of the transmitter and the receiver in which multiple MACs operate the multi carriers. Unlike the exemplary embodiment of FIG. 9, a plurality of MACs (MAC 0, . . . , MAC n−1) are one-to-one mapped to the plurality of physical layers (PHY 0, . . . , PHY n−1).

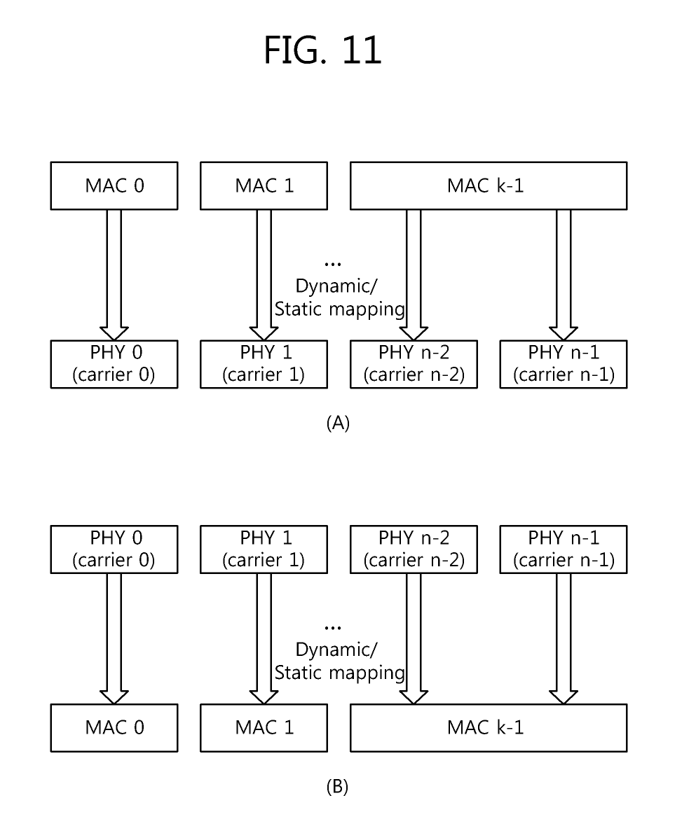

FIG. 11 is a diagram showing another example of the transmitter and the receiver in which the multiple MACs operate the multi carriers. Unlike the exemplary embodiment of FIG. 10, a total number k of MACs and a total number n of physical layers are different from each other. Some MACs (MAC 0 and MAC 1) are one-to-one mapped to the physical layers (PHY 0 and PHY 1) and some MACs (MAC k−1) are mapped to the plurality of physical layers (PHY n−2 and PHY n−2).

Cross-carrier scheduling may be performed between the multi carriers. That is, PDSCH of CC #2 may be indicated by a DL grant (or, UK grant) of PDCCH of CC #1. The component carrier transmitting the PDCCH is referred to as a reference carrier or a primary carrier and the component carrier transmitting the PDSCH is referred to as a secondary carrier.

The reference carrier is DL CC and/or UL CC that is primarily used between the base station and the UE (or, exchanges essential control information).

Although the communication between the base station and the UE is described below, the present invention may also be applied to the communication between the base station and a relay and/or the communication between the relay and the UE, when the relay is present. If the present invention is applied to the communication between the base station and the relay, the relay may perform the function of the UE. If the present invention is applied to the communication between the base station and the UE, the relay may perform the base station. Although not separately differentiated below, the UE may be a UE or the relay.

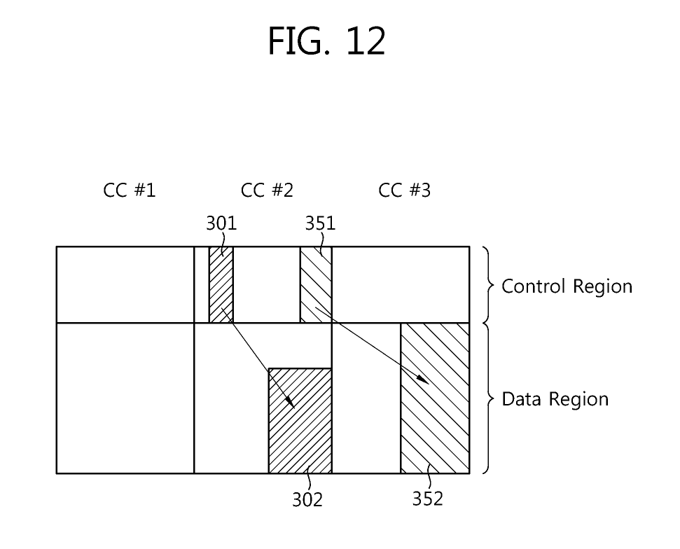

FIG. 12 is a diagram showing an example of separate coding. The separate coded PDCCH means that the PDCCH may carry the control information such as the resource allocation for the PDSCH/PUSCH for the single carrier. That is, the PDCCH and PDSCH and the PDCCH and the PUSCH each one-to-one corresponds to each other. For convenience, an example of the separate coding is described below based on the PDSCH that is the downlink channel, but may be applied to the relationship between the PDCCH and the PUSCH as it is.

A first PDCCH 301 of CC #2 carries downlink allocation for a first PDSCH 302 of CC #2. The first PDCCH 301 and the first PDSCH 302 are transmitted through the same carrier CC #2 and therefore, this may be provided the backward compatibility with the existing LTE.

A second PDCCH 351 of CC #2 carries downlink allocation for a second PDSCH 352 of CC #3. The second PDCCH 351 and the second PDSCH 352 are transmitted through different carriers. The DCI of the second PDCCH 351 may include a carrier indicator field (CIF) for the CC #3 transmitting the second PDSCH 352.

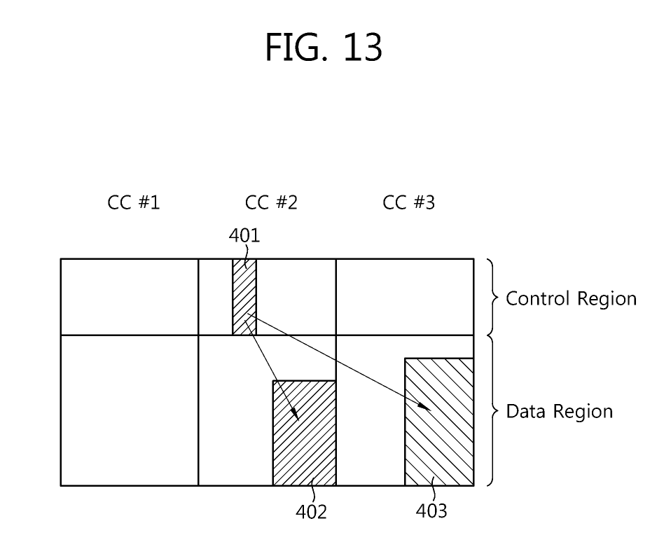

FIG. 13 is a diagram showing an example of joint coding. The joint coded PDCCH means that the single PDCCH may carry the resource allocation for the PDSCH/PUSCH of at least one carrier. The single PDCCH may be transmitted through the single component carrier or may be transmitted through the plurality of component carriers. For convenience, an example of the joint coding is described below based on the PDSCH that is the downlink channel, but may be applied to the relationship between the PDCCH and the PUSCH as it is.

A PDCCH 401 of CC #2 carries the downlink allocation for a PDSCH 402 of CC #2 and a PDSCH 403 of CC #3.

Hereinafter, for elucidating the description, the separated coded PDCCH is mainly described, but the technical idea of the present invention may also be applied to the joint coded PDCCH as it is.

After the UE completes an initial access process with the base station, the UE may obtain the carrier allocation information through the reference carrier from the base station. The initial access process includes cell search, synchronization acquisition, and random access processes. The carrier allocation information is information on at least one CC allocated to the UE among the available CCs of the system. The carrier allocation information may be received through UE-specific signaling such as an RRC message or the PDCCH. Alternatively, when the carrier allocation is performed in a cell unit or a UE group unit, the carrier allocation information may be received through cell-specific signaling or UE group signaling.

In the multiple carrier system, a linkage between the DL CC and the UL CC needs to be defined. The linkage means the mapping relationship between the DL CC transmitting the PDCCH carrying the UL grant and the UL CC using the UL grant. Alternatively, the linkage may be the mapping relationship between the CC transmitting data for the HARQ and the CC transmitting the HARQ ACK/NACK signal.

The linkage between the DL CC and the UL CC may be fixed, but may be changed between the cells/the UEs and may override through the cross-carrier scheduling.

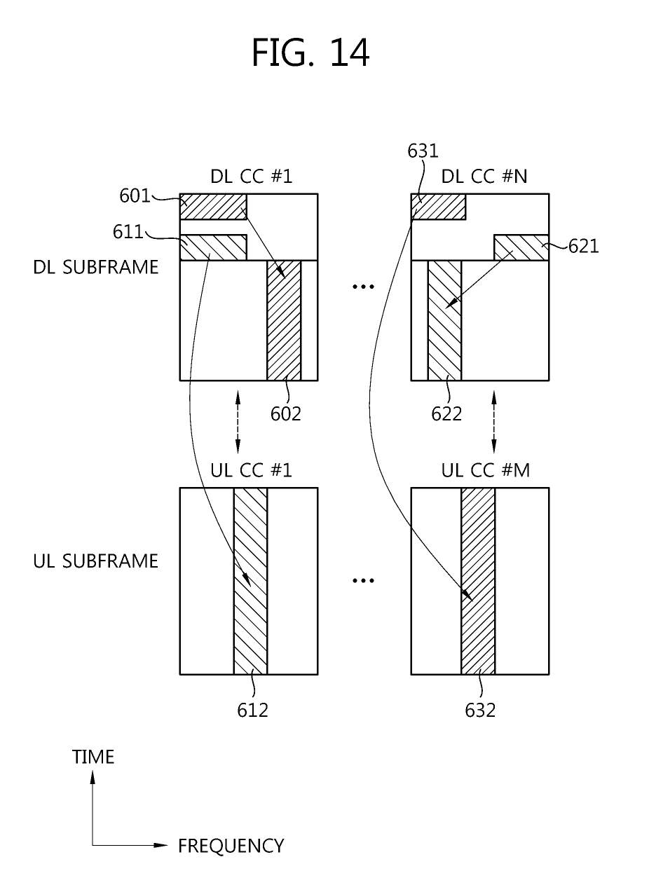

FIG. 14 is a diagram showing an example of the linkage between the DL CC and the UL CC. This corresponds to a case in which the cross-carrier scheduling is prohibited. The number of DL CCs is N and the number of UL CCs is M. It is assumed that DL CC #1 is linked with UL CC #1 and DL CC #N is linked with UL CC #M.

A PDCCH 601 of DL CC #1 carries the DL grant of a PDSCH 602 of DL CC #1. A PDCCH 611 of DL CC #1 carries a UL grant of a PDSCH 612 of UL CC #1.

A PDCCH 621 of DL CC #N carries a DL grant of a PDSCH 622 of DL CC #M. A PDCCH 631 of DL CC #N carries a UL grant of a PUSCH 632 of UL CC #1.

The DL CC linked with the UL CC receives the UL grant through the DL CC. Similarly, the HARQ ACK/NACK signal may be transmitted through the UL CC linked with the DL CC.

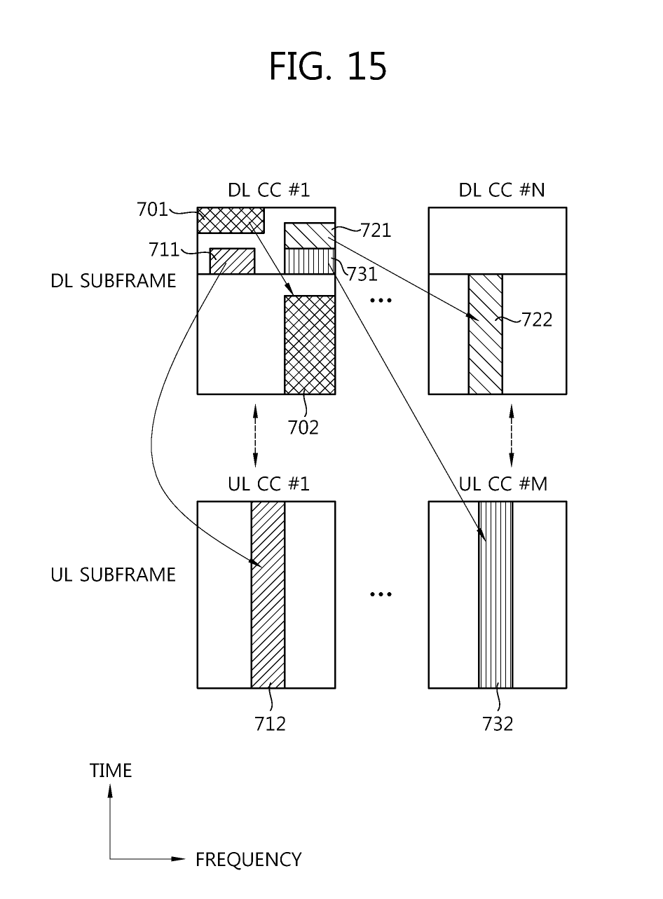

FIG. 15 is a diagram showing another example of the linkage between the DL CC and the UL CC. This corresponds to a case in which the cross-carrier scheduling is permitted. The cross-carrier scheduling may perform a scheduling of another CC regardless of the linkage between the DL CC and the UL CC.

A first PDCCH 701 of DL CC #1 carries a DL grant of a PDSCH 702 of DL CC #1. A second PDCCH 711 of DL CC #1 carries a UL grant of a PUSCH 712 of UL CC #1. A third PDCCH 721 of DL CC #1 carries a DL grant of a PDSCH 722 of DL CC #N. A fourth PDCCH 731 of DL CC #1 carries a UL grant of a PUSCH 732 of UL CC #M.

When the cross-carrier scheduling is applied, the PDCCH for the plurality of CCs is transmitted to the control region of the DL subframe and the DCI of the PDCCH may include the information on the UL/DL CC using the UL/DL grant. It is assumed that the information indicating the CC for the cross-carrier scheduling is the carrier indicator field (CIF).

In the multiple carrier system, the follow two characteristics need to be considered so as to define the common search space within the control region of the subframe.

First, the common search space may be a resource for transmitting the common control information on the UEs within the cell in terms of the cell. Therefore, a plan for setting the common search space in the plurality of DL CCs and a plan for transmitting the common control information need to be considered.

Second, the common search space may be a resource for monitoring the common control information in terms of the UE. The blind decoding for the PDCCH detection needs to be considered.

In terms of the cell, in order to support the backward compatibility with the 3GPP LTE considering only the single CC, there is a need to transmit the common control information through all the DL CCs. Alternatively, there is a need to transmit the common control information through the DL CC that provides the compatibility with the 3GPP LTE among the plurality of DL CCs.

However, as the number of DL CCs is increased, a burden according to the blind decoding is also increased in terms of the UE.

Therefore, a need exists for a plan to control a total frequency of the blind decoding performed for the UE to receive the common control information.

A plan to configure the common search space in the multiple carrier system proposed in the present invention will be described below.

The common control information means the control information obtained by the UE through the PDCCH monitoring within the common search space. In more detail, the common control information includes at least any one of the paging message identified by the P-RNTI, the random access response identified by the RA-RNTI, the SIB identified by the SI-RNTI, and the TPC command identified by the TPC-RNTI.

The DCI format that may be transmitted to the common search space in the 3GPP LTE is DCI format 0, 1A, 1C, 3, and 3A. This may be divided into two types of PDCCH as follows.

Type 1 PDCCH carries the DL grant for the PDSCH carrying the common control information. In this case, the common control information may be the paging message, the random access response, or the SIB. In type I PDCCH, the common RNTI used by all the UEs within the cell or the UE group RNTI used by the UE group within the cell may be CRC-masked. For example, the CRC of the DCI on the PDCCH may be masked to at least any one of the P-RNTI, the SI-RNTI, and the RA-RNTI.

In type 2 PDCCH, the DCI itself carries the common control information. This corresponds to DCI format 3/3A that transmits the transmit power control (TPC) command in the 3GPP LTE.

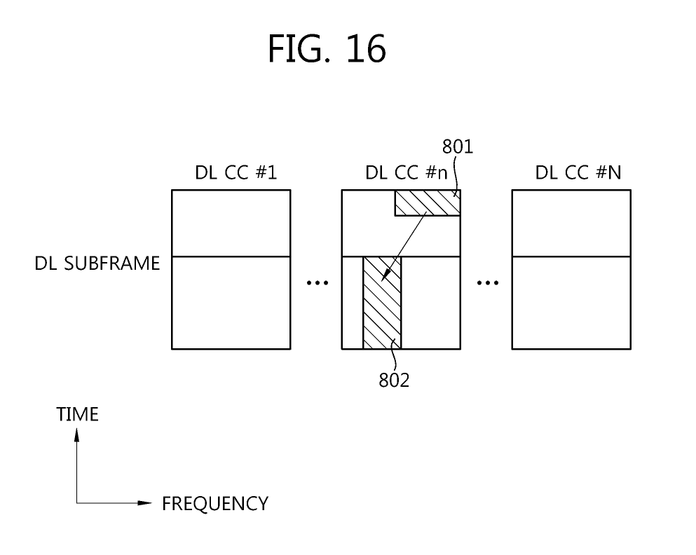

FIG. 16 is a diagram showing an example of the common control information transmission. DL CC #n (1≦n≦N) among N DL CCs is configured as the common DL CC used to transmit the common control information. Herein, the case in which the single DL CC is configured in the common DL CC is exemplified, but the plurality of common DL CC may be configured.

When the blind decoding is performed on all of the plurality of DL CCs, the total frequency of the PDCCH blind decoding is proportional to the number of DL CCs within the common search space. In order to reduce the burden due to the PDCCH blind decoding, the PDCCH blind decoding for the common control information is performed only in at least one common DL CC selected from the plurality of DL CCs.

The CC having the backward compatibility with the 3GPP LTE may be set as the common DL CC. The UE supporting only the single carrier monitors a PDCCH 801 within the common search space of the common DL CC to receive the common control information on a PDSCH 802.

The reference carrier may be set as the common DL CC.

The UE supporting the multi carriers first receives the common control information through the common DL CC. Further, the UE may receive the carrier specific control information or the UE-specific control information through the common DL CC and/or another DL CC.

The common DL CC may allow the base station to inform the UE of signaling such as the RRC message or the PDCCH.

The common DL CC may be the UE-specific CC, the cell-specific CC, or the UE group specific CC. Alternatively, the common DL CC may be changed according to the common control information. The SIB uses the DL CC #1 as the common DL CC and the TPC command uses the DL CC #2 as the common DL CC.

The common DL CC may be previously configured before the UE accesses the base station. In this case, in order to prevent the UE from accessing the base station through the remaining DL CC other than the common DL CC, the PDCCH may not be transmitted to the remaining DL CCs.

In the type 1 PDCCH, the PDSCH used by the DL grant is the same as the common DL CC transmitting the PDCCH or may be transmitted through another DL CC. When the cross-carrier scheduling is used, the DCI of the PDCCH may include the CIF. The bit size of the CIF may be configured as a ceil (log₂N) bit with respect to the number N of available DL CCs within the cell or a fixed size. Ceil (x) is a function indicating an integer equal to x or the smallest integer larger than x.

The CIF may be defined as a physical index of the CC or a logical index of the CC.

In the type 1 PDCCH, when the PDCCH and the corresponding PDSCH are always transmitted through the same common DL CC (that is, transmitted in the same subframe), the CIF may not be included in the DCI of the PDCCH.

In the type 2 PDCCH, the PDSCH is not transmitted, but the control information on the plurality of UEs may be multiplexed. Therefore, when the TPC command for i-th UE is TPCᵢ and the CIF for i-th UE is CIFᵢ, the DCI like {TPC₁, CIF₁, . . . , TPC_{K}, CIF_{K}} (K is the number of multiplexed TPC commands) may be configured. However, when the CIF is not used for the UL CC linked with the common DL CC, K-1 CIFs may be included in the DCI.

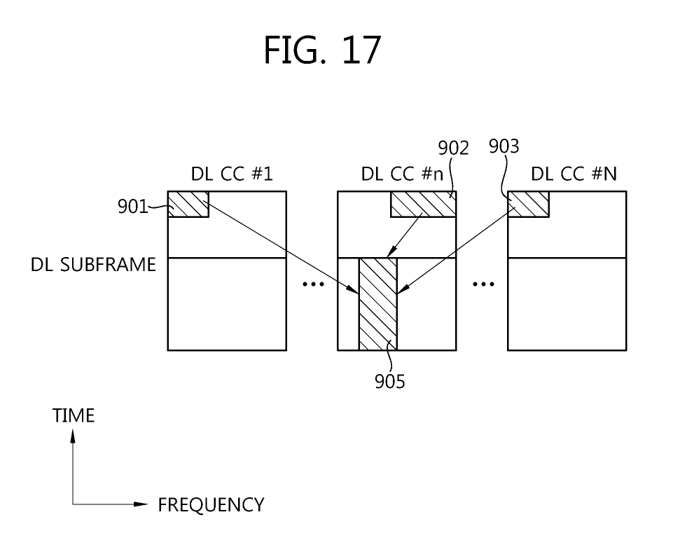

FIG. 17 is a diagram showing another example of common control information transmission. Comparing with the exemplary embodiment of FIG. 16, Q DL CCs (1≦Q≦N) among N DL CCs are configured as the common DL CC used to transmit the common control information.

This is a method that can transmit at least one PDCCH for the corresponding PDSCH on the plurality of DL CCs including the DL CCs transmitting the PDSCH so as to transmit the common control information on the single PDSCH. The method is a method for preventing the increase in the frequency of the blind decoding of the LTE-A UEs to which the cross-carrier scheduling may be applied while supporting the LTE UEs that do not the carrier aggregation and the LTE-A UEs that support only the single carrier.

The UE monitors each of the PDCCHs 901, 902, and 903 within the common search space of the common DL CC to receive the common control information on a PDSCH 905. It is possible to receive the common control information on the PDSCH 905 even though only one of the PDCCHs 901, 902, and 903 is decoded. Although only the type 1 PDCCH is shown, the method may be similarly applied to the type 2 PDCCH.

In the type 1 PDCCH, the PDSCH used by the DL grant is the same as the common DL CC transmitting the PDCCH or may be transmitted through another DL CC. When the cross-carrier scheduling is used, the DCI of the PDCCH may include the CIF. The bit size of the CIF may be configured as a ceil (log₂N) bit with respect to the number N of DL CCs that may be used within the cell or a fixed size.

In the type 2 PDCCH, when the PDSCH is not transmitted but the control information on the plurality of UEs is multiplexed, the DCI may be configured like {TPC1, CIF1, . . . , TPCK, CIFK} (K is the number of multiplexed TPC commands). However, when the CIF is not used for the UL CC linked with the common DL CC, K-1 CIFs may be included in the DCI.

A method of limiting CC for monitoring PDCCH will now be described in detail for each common control information.

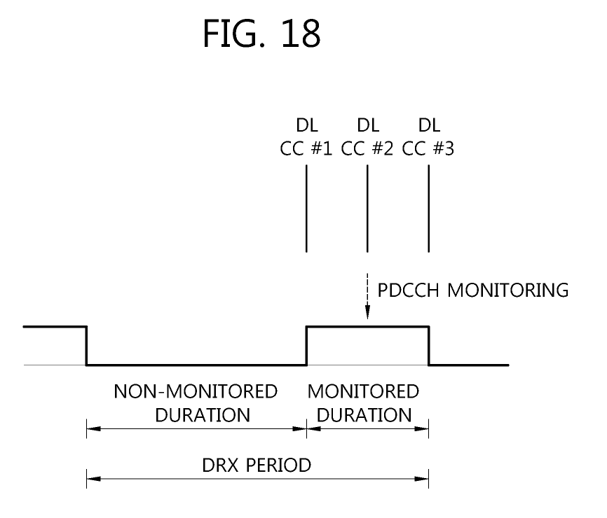

FIG. 18 is a diagram showing a monitoring of the paging message. The UE monitors the PDCCH within the common search space for a monitored duration existing for each discontinuous reception (DRX) period to receive the page message on the PDSCH. The CRC of the PDCCH carrying the DL grant for the PDSCH of the paging message is masked with the P-RNTI. The monitored duration may be defined by the number of consecutive subframes for monitoring the PDCCH. When the PDCCH is not successfully decoded for the monitored duration, the UE stops the monitoring of the PDCCH for non-monitored duration.

When the plurality of DL CCs are present, the power consumption of the UE may be increased due to the blind decoding in the case in which the PDCCHs for all the DL CCs are monitored in the monitored duration. Therefore, at least one DL CC (this becomes the above-mentioned common DL CC) for monitoring the PDCCH among the plurality of DL CCs may be set. This is to limit the DL CC for monitoring the PDCCH of the paging message.

FIG. 18 shows that when three DL CCs are present, the DL CC #2 is set as the common DL CC and the UE monitors only the DL CC #2 for the monitored duration.

The base station may inform the UE of the information on the common DL CC. The base station may transmit the information on the common DL CC to the UE through the system information, the RRC message, and/or the PDCCH. For example, the base station may inform the UE of the information on the common DL CC together with the DRX setting information associated with the DRX period.

The common DL CC may be configured without the separate signaling. For example, the UE may configure as the common DL CC the reference DL CC used before entering the DRX mode (or, when entering an RRC idle state in the RRC access status). Alternatively, it is possible to monitor the paging PDCCH only in the corresponding DL CC by setting the specific reference DL CC for paging monitoring.

The UE enters the DRX mode when the DL data transmission is not present for a predetermined period. The UE wakes up for the monitored duration of the DRX period to perform the PDCCH monitoring in the common search space of the subframe of the common DL CC. When errors do not occur in the CRC demasking of the P-RNTI, the paging message is received to the corresponding PDSCH. When the decoding of the PDCCH fails, the UE again enters the non-monitored duration of the DRX period.

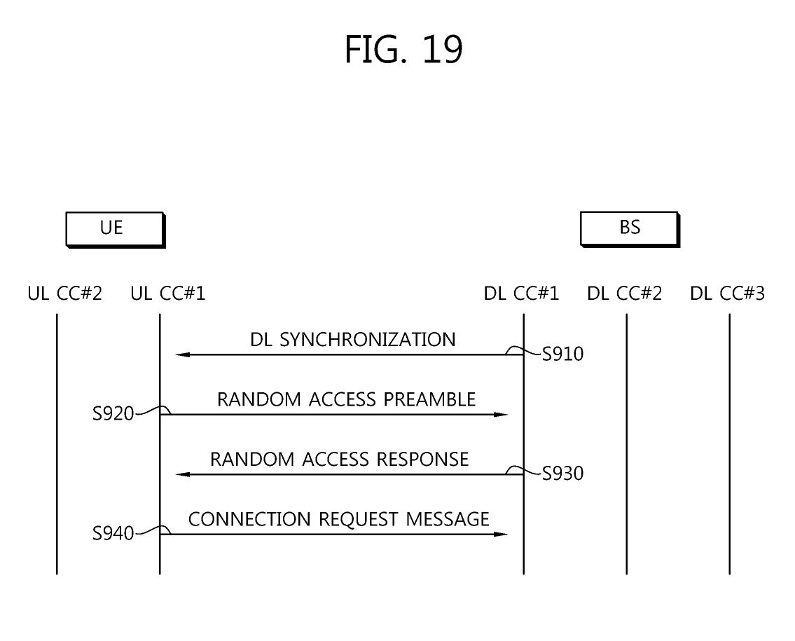

FIG. 19 is a diagram showing a random access process for limiting monitored CC.

The UE receives the PSS and the SSS to obtain the DL synchronization (S910). The UE obtains the DL CC #1 among three DL CCs.

The UE transmits temporarily selected random access preambles within the set of the random access preambles to the base station through the UL CC #1 (S920). The set of the random access preambles is generated using the information obtained as the system information on the PBCH. The UL CC #1 is UL CC linked through the DL CC #1 and EARFCN on the system information.

When the base station receives the random access preambles from the UE, the random access response is transmitted on physical downlink shared channel (PDSCH) (S930). The random access response includes uplink time alignment, uplink resource allocation, random access preamble index, and temporary cell-radio network temporary identifier (C-RNTI).

The PDSCH of the random access response is indicated by the PDCCH masked to the RA-RNTI and therefore, needs the PDCCH monitoring of the UE. When the UE performs the PDCCH monitoring for all of the three DL CCs such as the DL CC #1, DL CC #2, DL CC #3, the power consumption may be increased. Therefore, the UE performs the monitoring only for at least one common DL CC (in this case, DL CC #1). The common DL CC indicates the DL CC configured for the PDCCH monitoring of the random access response. The UE monitors the common search space of the common DL CC to receive the random access response.

When the random access preamble index of the random access response corresponds to its own random access preamble, the UE uses the uplink radio resource allocation to transmit the access request message to the UL-SCH (S940). The UL CC #1 transmitting the access request message may be the UL CC linked with the DL CC #1 receiving the random access response.

The burden due to the blind decoding may be reduced by limiting the DL CC for monitoring the random access response.

The base station may inform the UE of the information on the common DL CC. The base station may transmit the information on the common DL CC to the UE through the system information, the RRC message, and/or the PDCCH.

The DL CC receiving the PSS and the SSS may be set as the common DL CC. Alternatively, the DL CC linked with the UL CC used to transmit the random access preambles may be set as the common DL CC. In this case, the common CC may be the DL CC that performs the random access.

The PDCCH of the random access response is masked by the temporary C-RNTI and therefor, the PDCCH used by the temporary C-RNTI may be defined so as to be transmitted only through the common DL CC.

The number of DL CCs, the number of UL CCs, the position of the UL CC to which the random access preamble is transmitted, the position of the common DL CC, or the like, are only an example and are not limited.

The PDCCH monitoring for the system information will now be described.

The 3GPP LTE has two system information. One is the system information (referred to as a master information block (MIB)) on the PBCH and the other is the system information (referred to as a system information block (SIB)) on the PDSCH. The MIB includes the most essential physical layer information in the cell. The PDSCH of the SIB is identified by the PDCCH in which the SI-RNTI is masked to the CRC.

When the SIB is transmitted through all the DL CCs, the burden due to the blind decoding may be increased. Therefore, the SIB is transmitted only to at least one common DL CC. The UE may perform the PDCCH monitoring for the SIB only within the common search space of the common DL CC and therefore, the power consumption may be reduced.

When the PDSCH and the PDCCH of the SIB are transmitted in the same DL CC, the compatibility with the LTE may be secured. However, in order to obtain all the SIBs for the plurality of CCs, the UE needs to search the overall common search space.

In order to receive the SIBs for each subframe without the SIB being frequently updated, it is inefficient for the UE to perform the blind decoding on the common search space of all of the DL CCs. Therefore, when the SIB is updated, the base station may inform the UE of the update indication information on whether the SIB is updated. The UE obtaining the update indication information monitors the common DL CC later to obtain the updated SIB. The update indication information may be informed through the paging message or the MIB.

When the cross-carrier scheduling in which the PDSCH and the PDCCH of the SIB are transmitted from different DL CCs is permitted, the DCI of the PDCCH may include the CIF.

The single SIB on the single PDSCH may include the SIB for the single CC. Alternatively, the single SIB on the single PDSCH may include the SIB for the plurality of CCs. The latter means that the UE may receive the SIBs for the plurality of CCs by the single PDCCH monitoring.

The PDCCH monitoring for the TPC command will now be described.

The 3GPP LTE multiplexes the plurality of TPC commands for the plurality of UEs to configure the DCI. DCI format 3 is for the TPC command of 2 bits and DCI format 3A is for the TPC command of 1 bit. The burden due to the blind decoding may be reduced by performing the PDCCH monitoring for the TPC commands only within the common search space of the common DL CC.

In order to reduce the complexity of the blind decoding, it is possible to limit the UE multiplexed to the DCI. For example, the UEs multiplexed based on the UL CC linked with the common DL CC may be grouped. The UE using the plurality of UL CCs receives the TPC commands for each UL CC through another common DL CC. Alternatively, the UEs having the same reference UL CC may be grouped.

Alternatively, the TPC commands for all the UL CCs used by each UE may be included in the DCI. When the UE 1 uses two UL CCs and the UE 2 uses three UL CCs, the DCI can be constructed as {TPC₁₁, TPC₁₂, TPC₂₁, TPC₂₂, TPC₂₃}. TPCᵢⱼ represents a TPC command for j-th UL CC of i-th UE.

The monitoring of the common control information on the non-monitored carrier will now be described.

At least one DL CC among the plurality of DL CCs may be configured as the CC that does not monitor the PDCCH. This is referred to as the non-monitored CC. The non-monitored CC may be defined by CC that deactivates the PDCCH monitoring even when the PDCCH can be transmitted or may be defined by CC (PDCCH-less CC) not transmitting the PDCCH since the control region is not defined.

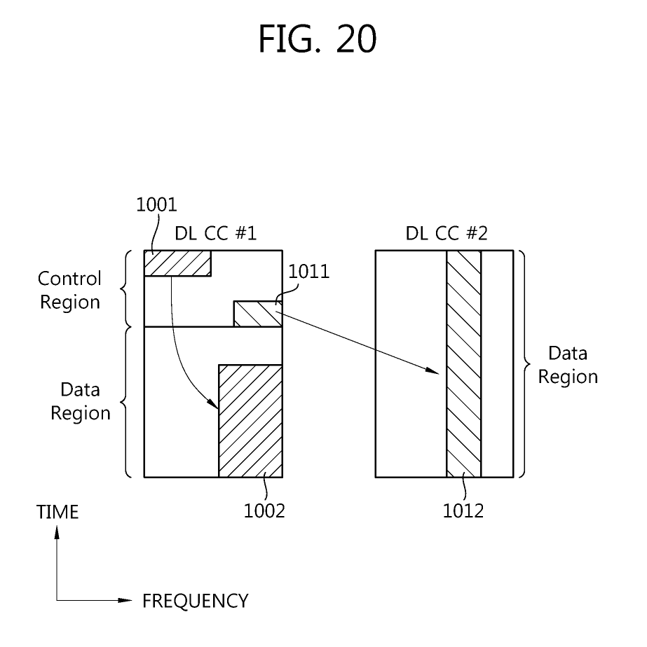

FIG. 20 is a diagram showing an example of the common control information transmission for non-monitored carriers. The DL CC #1 is the reference DL CC in which the control region and the data region are defined, but the DL CC #2 is the non-monitored CC as the PDCCH-less CC without the control region.

A PDCCH 1001 of DL CC #1 indicates a PDSCH 1002 of DL CC #1. A PDCCH 1011 of DL CC #1 indicates a PDSCH 1012 of DL CC #2.

In order to transmit the common control information on the DL CC #2, the PDCCH 1001 or the PDCCH 1011 of DL CC #1 may be used. When the PDCCH 1001 of DL CC #1 is used, the common control information on the DL CC #2 may be transmitted to the PDSCH 1002 of DL CC #1. When the PDCCH 1011 of DL CC #1 is used, the common control information on the DL CC #2 may be transmitted to the PDSCH 1012 of DL CC #2.

The base station may inform or previously define the UE of the information on the DL CC #1 (this may be referred to as the reference carrier) monitoring the PDCCH for the common control information of the DL CC #2.

The DL CC #1 monitoring the PDCCH for the common control information of the DL CC #2 may be the UE-specific CC, the cell-specific CC, or the UE group-specific CC. Alternatively, the DL CC #1 may be changed according to the common control information.

The setting of the CCE aggregation level for the common search space will now be described.

The CCE aggregation level for the existing common search space is 4 or 8 as shown in Table 1. However, in order to define the common search space of the above-mentioned common DL CC, the CCE aggregation level needs to be maximally expanded or reduced.

As a first example, the CCE aggregation level that is expanded or reduced for the common search space of the common DL CC may be a multiple of 2, 4, or 8.

As a second example, the CCE aggregation level that is expanded or reduced for the common search space of the common DL CC may be defined by a multiple of 2, 4, or 8 that most approaches results obtained by multiplying any integer by the number of common DL CCs or the number of UL CCs and then, multiplying 16 thereby.

As a third example, the base station may inform the UE of the CCE aggregation level that is expanded or reduced for the common search space of the common DL CC through the RRC message, the SIB, or the PDCCH.

The UE performs the blind decoding on the CCE aggregation level (for example, 2 or 16) that is added within the common search space. A legacy UE supporting only the LTE does not perform the blind decoding on the added CCE aggregation level and therefore, the added CCE aggregation level may be used for the transmission of the DCI regarding the multi-carrier related information.

The common search space is defined by 16 CCEs. When the set of available CCE aggregation level is expanded to {1, 2, 4, 8}, CCE aggregation level 2 may set the number of PDCCH candidates to be 8 and CCE aggregation level 1 may set the number of PDCCH candidate to be 16.

Alternatively, only some areas of the common search space for the added CCE aggregation level {1, 2} may be used. For example, when only 8 CCEs are used, the CCE aggregation level 2 may set the number of PDCCH candidates to be 4 and the CCE aggregation level 1 may set the number of PDCCH candidates to be 8.

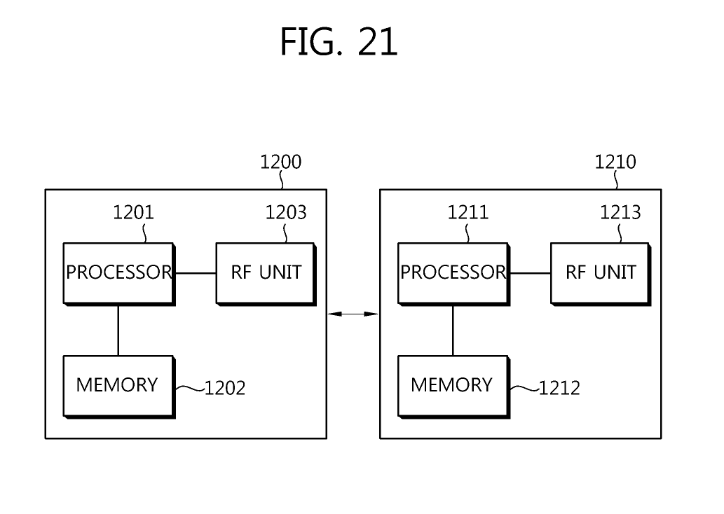

FIG. 21 is a block diagram showing a radio communication system according to an exemplary embodiment of the present invention.

A base station 1200 includes a processor 1201, a memory 1202, and a radio frequency (RF) unit 1203.

The processor 1201 implements the proposed function, process and/or method. In the above-mentioned exemplary embodiment, an operation of the base station may be implemented by the processor 1201. The processor 1201 may support an operation for multi carriers and set the downlink physical channel.

The memory 1202 is connected with the processor 1201 to store protocols or parameters for a multi-carrier operation. The RF unit 1203 is connected with the processor 1201 to transmit and/or receive radio signals.

A UE 1210 includes a processor 1211, a memory 1212, and a radio frequency (RF) unit 1213.

The processor 1211 implements the proposed function, process and/or method. In the above-mentioned exemplary embodiment, an operation of the UE may be implemented by the processor 1211. The processor 1211 may support the multi-carrier operation and monitor the PDCCH within the common search space on the common DL CC.

The memory 1212 is connected with the processor 1211 to store protocols or parameters for a multi-carrier operation. The RF unit 1213 is connected with the processor 1211 to transmit and/or receive radio signals.

The processor 1201, 1211 may include Application-Specific Integrated Circuits (ASICs), other chipsets, logic circuits, and/or data processors. The memory 1202, 1212 may include Read-Only Memory (ROM), Random Access Memory (RAM), flash memory, memory cards, storage media and/or other storage devices. The RF unit 1203, 1213 may include a baseband circuit for processing a radio signal. When the above-described embodiment is implemented in software, the above-described scheme may be implemented using a module (process or function) which performs the above function. The module may be stored in the memory 1202, 1212 and executed by the processor 1201, 1211. The memory 1202, 1212 may be placed inside or outside the processor 1201, 1211 and connected to the processor 1201, 1211 using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

The above-described embodiments include various aspects of examples. Although all possible combinations for describing the various aspects may not be described, those skilled in the art may appreciate that other combinations are possible. Accordingly, the present invention should be construed to include all other replacements, modifications, and changes which fall within the scope of the claims.

1. A method for monitoring a control channel in a multi-carrier system, comprising:
configuring a common downlink carrier for monitoring a plurality of candidate control channels used to receive common control information among a plurality of carriers;
monitoring the plurality of candidate control channels in a common search space of the common downlink carrier; and
receiving the common control information on the control channel that is successfully decoded among the plurality of candidate control channels.

2. The method of claim 1, wherein a downlink grant is received on the control channel and the common control information is received on a data channel indicated by the downlink grant.

3. The method of claim 2, wherein the data channel is received through a downlink carrier different from the common downlink carrier.

4. The method of claim 3, wherein the downlink grant includes a carrier indicator field (CIF) indicating the downlink carrier used to receive the data channel.

5. The method of claim 1, wherein the common control information includes at least one of system information, a paging message, a random access response, and a transmit power control (TPC) command.

6. The method of claim 1, wherein information on the common downlink carrier is informed to a user equipment by a base station.

7. A user equipment for monitoring a control channel in a multi-carrier system, comprising:
an RF unit for transmitting and receiving radio signals; and
a processor operatively connected to the RF unit and configured to:
configure a common downlink carrier for monitoring a plurality of candidate control channels used to receive common control information among a plurality of carriers;
monitor the plurality of candidate control channels in a common search space of the common downlink carrier; and
receive the common control information on the control channel that is successfully decoded among the plurality of candidate control channels.

8. The user equipment of claim 7, wherein the processor is configured to receive a downlink grant on the control channel and receive the common control information on a data channel indicated by the downlink grant.

9. The user equipment of claim 8, wherein the data channel is received through a downlink carrier different from the common downlink carrier.

10. The user equipment of claim 9, wherein the downlink grant includes a carrier indicator field (CIF) indicating the downlink carrier used to receive the data channel.

11. The user equipment of claim 7, wherein the common control information includes at least one of system information, a paging message, a random access response, and a transmit power control (TPC) command.
